(19) United States
(12) Patent Application Publication
(10) Pub. No.: US 2018/0361924 A1
(43) Pub. Date: Dec. 20, 2018

(54) INDOOR ILLUMINATION LAMP

(71) Applicant: Yazaki Corporation, Tokyo (JP)

(72) Inventors: Takayuki Ikeda, Shizuoka (JP); Ken Suzuki, Shizuoka (JP)

(73) Assignee: Yazaki Corporation, Tokyo (JP)

(21) Appl. No.: 16/000,309

(22) Filed: Jun. 5, 2018

(30) Foreign Application Priority Data
Jun. 15, 2017 (JP) 2017-117470

(51) Int. Cl. B60Q 3/85; B60Q 3/74; B60Q 3/82

(52) U.S. Cl. CPC B60Q 3/85; B60Q 3/82; B60Q 3/74

(57) ABSTRACT

An indoor illumination lamp as a map lamp includes a housing to be attached to an interior ceiling of a vehicle and provided with an opening, a switch knob arranged at the opening of the housing and including a light-transmitting logo part, and a three-color light emitting diode arranged in the housing and capable of emitting light toward the logo part.

### CROSS REFERENCE TO RELATED APPLICATION

The present application is based on, and claims priority from Japanese Patent Application No. 2017-117470, filed Jun. 15, 2017, the disclosure of which is hereby incorporated by reference herein in its entirety.

### BACKGROUND

### Technical Field

The present application relates to an indoor illumination lamp to be attached to an interior ceiling of a vehicle.

### Related Art

Various indoor illumination lamps to be attached to an interior ceiling of a vehicle have been proposed (see JP 2007-066630 A and JP 4831097 B). A conventional example of such an indoor illumination lamp includes a housing to be attached to an interior ceiling of a vehicle, a switch knob provided on a lower face side of the housing and provided with a light-transmitting logo part, and a single-color light emitting diode arranged in the housing.

The light emitting diode is turned on when an ignition key is put into ON state. The logo part is in a lighting state day and night.

The logo part in a lighting state allows an occupant to easily recognize the position of the switch knob and the function of the switch knob.

### SUMMARY

However, such a conventional indoor illumination lamp sometimes has poor visibility, since the indoor illumination lamp uses a single-color light emitting diode. In a case of white light emission, for example, it is hard to see the light during the daytime.

Consequently, the present application has been made with the aim of solving the above problem, and an object of the present application is to provide an indoor illumination lamp which can improve the visibility of a logo part.

An indoor illumination lamp according to an aspect of the present application includes a housing to be attached to an interior ceiling of a vehicle and provided with an opening, a switch knob arranged at the opening of the housing and including a light-transmitting logo part, and a three-color light emitting diode arranged in the housing and capable of emitting light toward the logo part.

With the indoor illumination lamp according to the aspect of the present application, it is possible to cause the logo part to emit light with a color having high visibility according to the external environment or the like, and it is therefore possible to improve the visibility of the logo part.

### BRIEF DESCRIPTION OF DRAWINGS

FIG. 1 is a view of an indoor illumination lamp (map lamp) according to an embodiment obtained when looking up an interior ceiling from a vehicle interior.

FIG. 2 is a sectional view along line A-A in FIG. 1.

FIG. 3 is a circuit block diagram of the indoor illumination lamp according to the embodiment.

### DETAILED DESCRIPTION

A following description will explain an embodiment with reference to the drawings.

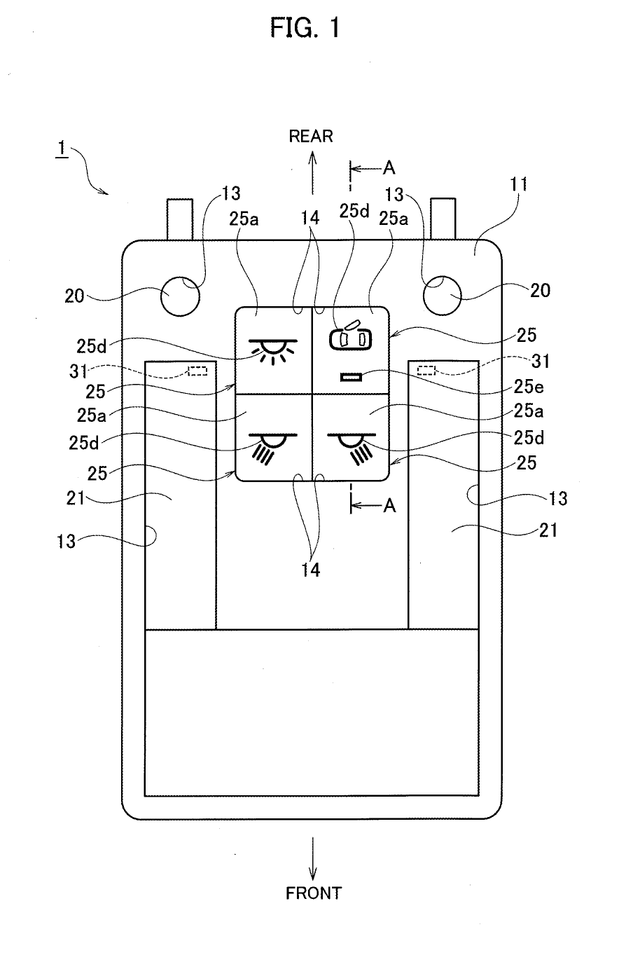

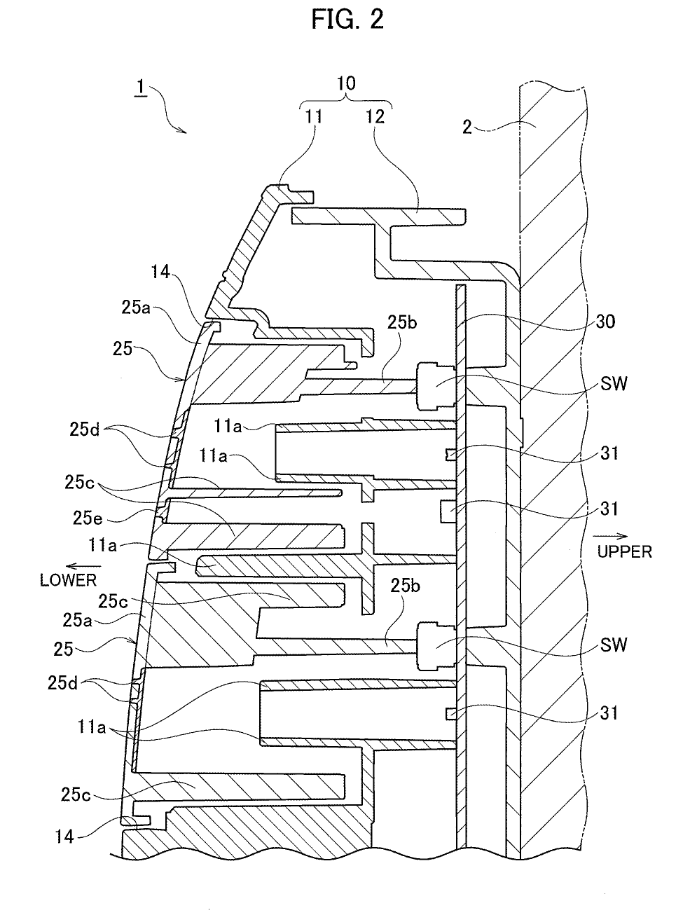

FIGS. 1 to 3 illustrate an indoor illumination lamp according to an embodiment.

A map lamp 1, which is an indoor illumination lamp according to an embodiment, is attached to an interior ceiling 2 at a position in front of a front seat of a vehicle.

The map lamp 1 includes a housing 10 attached to the interior ceiling 2, a pair of right and left spotlight lenses 20 and a pair of right and left interior light lenses 21, which are arranged on a lower face side of the housing 10, a plurality of switch knobs 25 arranged on the lower face side of the housing 10, and a substrate 30 arranged in the housing 10.

The housing 10 is formed of a member which does not transmit light. The housing 10 includes a housing body 11, and a ceiling side housing part 12 assembled with the housing body 11 and covering a ceiling side of the housing body 11. The housing body 11 includes a plurality of light-shielding partition walls 11a. A plurality of openings 13, 14 is formed on the lower face side of the housing body 11 so that respective spaces partitioned by the plurality of light-shielding partition walls 11a are opened.

The ceiling side housing part 12 is provided with an attachment part (not illustrated) to be attached to the interior ceiling 2.

The spotlight lenses 20 and the interior light lenses 21 are arranged to cover the respective openings 13. Each of the spotlight lenses 20 has a face exposed to the vehicle interior, the face having a small circular shape. Each of the interior light lenses 21 has a face exposed to the vehicle interior, the face having a large square shape.

Each of the switch knobs 25 is arranged to cover a corresponding opening 14 on the lower face side of the housing body 11. Each of the switch knobs 25 is of push type. Each of the switch knobs 25 excluding a logo part 25d is formed of a member which does not transmit light. Each of the switch knobs 25 includes an operation part 25a exposed to the surface of the housing body 11, a switch depression rod 25b protruded in the housing body 11, and a light-shielding wall 25c protruded in the housing body 11.

Each operation part 25a includes the logo part 25d formed of a member which transmits light. The logo part 25d has a mark shape with which a function allocated to a corresponding switch knob 25 can be recognized visually. To the operation part 25a of one switch knob 25, an indicator lens 25e is attached in addition to the logo part 25d.

Each light-shielding wall 25c prevents irradiation light from each three-color light emitting diode 31 from leaking to another irradiation area, together with the light-shielding partition walls 11a of the housing body 11. Each light-shielding wall 25c also functions as a movement guide to be used when a corresponding switch knob 25 is pushed.

The substrate 30 is in contact with an upper face side of each of the light-shielding partition walls 11a of the housing body 11. The substrate 30 closes a ceiling side of the plurality of openings formed by partitioning with the light-shielding partition walls 11a. That is, irradiation light from the three-color light emitting diodes 31 is kept from leaking toward the ceiling side housing part 12. On the substrate 30, the plurality of three-color light emitting diodes 31, a plurality of switching elements SW, and the like are mounted. Each of the three-color light emitting diodes 31 is arranged in each of areas, which are partitioned by the light-shielding partition walls 11a and correspond to the respective spotlight lenses 20, interior light lenses 21, and the respective switch knobs 25. Regarding a switch knob 25 having the indicator lens 25e, each three-color light emitting diode 31 is arranged not only at the logo part 25d but also in an area corresponding to the indicator lens 25e.

Each three-color light emitting diode 31 incorporates a red (R) light emitting element, a green (G) light emitting element, and a blue (B) light emitting element, and can emit light of a predetermined color according to a current value, for example.

Each switching element SW is arranged at a position right below a switch depression rod 25b of each switch knob 25.

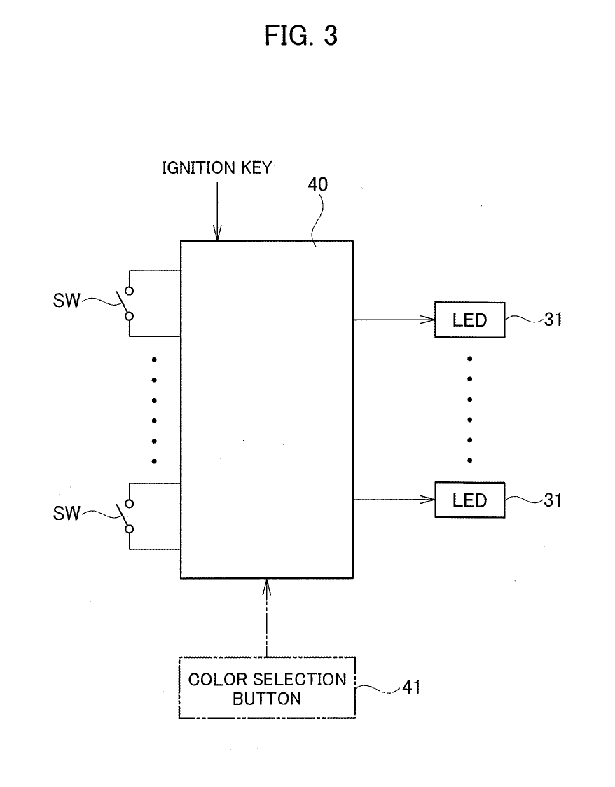

A control unit 40 controls lighting on/off of each three-color light emitting diode 31 on the basis of ON/OFF information of an ignition key (not illustrated) and ON/OFF information of each switching element SW as illustrated in FIG. 3. In a state where the ignition key is ON, for example, the three-color light emitting diodes 31 for irradiation of the logo parts 25d of the switch knobs 25 and the indicator lens 25e are always in a lighting state. That is, the logo parts 25d and the indicator lens 25e are in a lighting state day and night. According to ON/OFF of each switching element SW or the door open/close state, the three-color light emitting diodes 31 for interior light and the three-color light emitting diodes 31 for spotlight are lighted on/off.

As described above, the map lamp (indoor illumination lamp) 1 according to the embodiment includes the housing 10 to be attached to the interior ceiling 2 of a vehicle and provided with the opening 14 on the lower face side, the switch knob 25 arranged at the opening 14 of the housing 10 and including the light-transmitting logo part 25d, and the three-color light emitting diode 31 arranged in the housing 10 and capable of emitting light toward the logo part 25d.

Accordingly, it is possible to cause the logo part 25d to emit light with a color having high visibility according to the external environment or the like, and it is therefore possible to improve the visibility of the logo part 25d.

Regarding the map lamp 1 according to the embodiment, the plurality of switch knobs 25 having logo parts 25d is arranged. Accordingly, it is easy to recognize positions of the plurality of switch knobs 25 and functions of the switch knobs 25.

With the map lamp 1 according to the embodiment, it is possible to improve the visibility by changing the color of light emitted from the logo part 25d of each switch knob 25 between ON state and OFF state of the three-color light emitting diode 31 for the spot lamp or the three-color light emitting diode 31 for the room lamp.

Moreover, regarding the map lamp 1 according to the embodiment, a color selection button 41 for the user may be provided as illustrated by the virtual lines in FIG. 3, so that the color of light emitted from the logo parts 25d of the switch knobs 25 can be changed to a color required by the user.

Although the indoor illumination lamp has been described as a map lamp 1 in the present embodiment, the indoor illumination lamp can be also applied to a dome lamp or a room lamp.

What is claimed is:

1. An indoor illumination lamp, comprising:
a housing to be attached to an interior ceiling of a vehicle and provided with an opening;
a switch knob arranged at the opening of the housing and including a light-transmitting logo part; and
a three-color light emitting diode arranged in the housing and capable of emitting light toward the logo part.

2. The indoor illumination lamp according to claim 1, wherein
the switch knob includes a plurality of switch knobs.
